(19) United States
(12) Patent Application Publication
(10) Pub. No.: US 2009/0214902 A1
(43) Pub. Date: Aug. 27, 2009

(54) Adsorptive Bulk Separation for Upgrading Gas Streams

(76) Inventors: Aaron M. Pelman, Vancouver (CA); Surajit Roy, Burnaby (CA); Sean Patrick Mezei, Burnaby (CA)

Correspondence Address: KLARQUIST SPARKMAN, LLP, 121 SW SALMON STREET, SUITE 1600, PORTLAND, OR, 97204, US

(21) Appl. No.: 11/991,893

(22) PCT Filed: Jun. 15, 2006
(86) PCT No.: PCT/CA2006/001029

§ 371 Date: Feb. 9, 2009

Related U.S. Application Data
(60) Provisional application No. 60/691,001, filed on Jun. 15, 2005.

(51) Int. Cl. H01M 8/14

(52) U.S. Cl. 429/16; 96/135; 95/148; 95/95; 95/96; 95/97; 95/98; 429/34

(57) ABSTRACT

Disclosed embodiments concern adsorptive gas bulk separation systems and methods that may be advantageously less expensive to utilize than some in the prior art. Embodiments of the present invention concern processing a feed gas source, typically comprising at least one fuel gas component and at least one diluent, using a displacement purge adsorptive separator apparatus comprising at least one adsorbent bed, at least one purge gas source for purge regeneration of the at least one adsorbent bed, and a product conduit for supplying upgraded gas product. The feed gas typically is supplied to the displacement purge adsorptive separator apparatus at substantially the ambient pressure of the feed gas source. The displacement purge adsorptive separator apparatus is operable to adsorb at least a portion of the at least one diluent component from the feed gas stream to produce an upgraded gas.

### CROSS REFERENCE TO RELATED APPLICATION

This application claims the benefit of the earlier filing date of U.S. Provisional Application No. 60/691,001, filed Jun. 15, 2005, which is incorporated herein by reference in its entirety.

### FIELD

The present disclosure relates to systems for separation of gas streams, and more particularly to systems for upgrading fuel gas streams by adsorptive bulk separation.

### BACKGROUND

Gaseous fuels are widely used in commercial and industrial fields to provide energy for a desired process or operation. Many such gaseous fuels are initially generated or captured in relatively impure forms as one of multiple components of a mixed gas stream. It is known to preferably separate at least a portion of the undesirable non-fuel gas components from the desired fuel gas component in the mixed gas stream before use, to form an upgraded fuel gas stream with a desirably increased concentration of the fuel gas component relative to the mixed gas feed stream. Such an upgraded fuel gas stream may then be used by any compatible fuel-consuming process or machinery to make use of the energy fuel value of the upgraded fuel gas stream. One of the most common uses for fuel gas streams is as fuel for combustion processes, typically to generate either heat or power, or some combination of both.

Mixed gas streams comprising various concentrations of fuel gas components and other diluent components or impurities may be found in many known sources of fuel gases comprising biogas, anaerobic digester gas, natural gas, coke oven gas, blast furnace gas, PSA exhaust gas, and fuel cell exhaust gas. It is desirable to separate at least a portion of the non-fuel components of such mixed gas streams to yield an upgraded fuel gas stream with increased concentration of the fuel gas component(s), particularly in applications where the initial concentration of the fuel gas in the mixed gas feed stream is insufficient or less than optimum for use of the fuel gas in a particular process or operation, wherein the upgraded fuel gas may be more desirably suited for use.

Some presently known methods for performing bulk separation of dilute fuel gas streams comprise membrane separation systems, pressure swing adsorption systems utilizing granular adsorbent materials (such as disclosed in U.S. Pat. No. 4,770,676), and liquid or solid absorbent systems (such as disclosed in U.S. Patent Application Publication No. 20050066815). Such membrane separation systems and pressure swing adsorption systems typically require compressing the feed gas stream to substantial pressure prior to separation. This requires significant energy consumption during the compression process, as well as the operation of typically expensive and large compression equipment. Such liquid or solid absorbent systems typically require periodic regeneration of the absorbent material using heated gas or liquid streams, and/or by heating the absorbent material itself, such heating processes consuming significant energy. In addition, such absorbent separation systems typically operate at slow cycle speeds, and require using large and expensive absorbent contacting equipment, such as absorbent column towers with large inventories of adsorbent material.

### SUMMARY

Disclosed embodiments of the present invention provide systems for adsorptive bulk separation of gas streams, particularly fuel gas streams, that address some of the shortcomings of the prior art. Particular disclosed embodiments of the present invention provide adsorptive gas mixture bulk separation systems that may be advantageously less expensive to produce and operate than some systems according to the prior art.

A first embodiment of a disclosed system for adsorptive bulk separation of a gas stream having at least a first component and a diluent component comprises a displacement purge adsorptive separator operably coupled to a feed gas source. The separator comprises at least one adsorbent bed, at least one purge gas source for displacement purge regeneration of the at least one adsorbent bed, and a product conduit for supplying a gas product. The displacement purge adsorptive separator apparatus adsorbs at least a portion of the at least one diluent component from the feed gas, thereby producing a gas product. A second fluid processing device is fluidly coupled to the displacement purge adsorptive separator, the feed gas source, or both. The second fluid processing device typically is an adsorptive fluid separator, an engine, or combinations thereof. For certain embodiments, the adsorptive separator is downstream of the displacement purge adsorptive separator. For other embodiments, the adsorptive separator is upstream of the displacement purge adsorptive separator.

Another embodiment of the present invention concerns a system for adsorptive bulk separation of a fuel gas stream. A feed gas source comprising at least one fuel gas component and at least one diluent component is fluidly connected via a feed gas conduit to a displacement purge adsorptive separator apparatus comprising at least one adsorbent bed, at least one purge gas source, typically an external purge gas source, for purge regeneration of the at least one adsorbent bed and a product conduit for supplying an upgraded fuel gas product. For certain embodiments, feed gas is supplied to the displacement purge adsorptive separator apparatus at substantially the ambient pressure of the feed gas source. The displacement purge adsorptive separator apparatus is operable to adsorb at least a portion of the at least one diluent component from the feed gas stream to produce an upgraded fuel gas product, which is provided for use as an upgraded fuel source for downstream fuel usage via a product conduit.

For embodiments useful for processing a feed stream comprising at least one fuel component, the feed gas may comprise, by way of example, at least one of the following fuel gas streams: landfill gas, biogas, digester gas (including anaerobic digester gas), fuel cell exhaust gas, natural gas, coalbed methane gas, coke oven gas, blast furnace gas, and exhaust gas from a fuel-purification pressure swing adsorption (PSA) system. The fuel gas component of the feed gas stream may comprise at least one of methane or hydrogen gas. The diluent component of the feed gas stream may comprise various materials, such as at least one of a carbon oxide, such as carbon dioxide, nitrogen gas, or water vapor.

The displacement purge adsorptive separator preferably comprises a rotary displacement purge adsorptive separator comprising multiple adsorbent beds comprising adsorbent materials. At least a displacement purge process is used to regenerate the adsorbent beds, such as has been disclosed in Applicant's previously filed U.S. patent application Ser. No. 10/389,539, which is incorporated herein by reference. Preferably, the adsorbent materials may be formed as parallel passage contactor adsorbent beds, which are advantageously not susceptible to fluidization of the adsorbent material relative to conventional adsorbent beds comprising beaded adsorbent materials. Exemplary such preferred parallel passage contactor adsorbent beds have been disclosed in Applicant's previously filed U.S. patent application Ser. No. 10/041,536, which is incorporated herein by reference. Such a rotary displacement purge adsorptive separator may be configured to additionally utilize a pressure swing and/or temperature swing process in addition to a displacement purge process to perform the adsorptive separation process and/or to regenerate the adsorbent beds. However, such a rotary displacement purge adsorptive separator preferably is configured to regenerate the adsorbent beds substantially or at least in major part by a displacement purge process, such that additional compression/vacuum equipment and/or heating/cooling equipment are not required to facilitate the adsorption process or to regenerate the adsorbent beds in the displacement purge adsorptive separator. This results in advantageously reduced cost and/or reduced complexity relative to conventional pressure and/or temperature swing adsorptive separators requiring such additional equipment to generate a substantial swing in pressure and/or temperature to perform the adsorption process and regenerate the adsorbent beds.

Various components may be used in combination with the disclosed system embodiments. For example, the system may include a feed blower. The blower may be upstream of the bulk displacement separator, or downstream of the bulk displacement separator. The feed blower can be used to provide gas streams at substantially ambient pressures, or might be used to provide feed gas to the system at a pressure higher than the ambient pressure but substantially lower than a corresponding pressure swing adsorption feed pressure.

Another disclosed embodiment of the system further comprises a steam reformer hydrogen generator. For these embodiments, the product of the bulk separator used to upgrade hydrogen pressure swing adsorption exhaust gas is returned back to an inlet of the steam reformer hydrogen generator.

A person of ordinary skill in the art will appreciate that at least one additional purification system can be used in combination with disclosed systems. This additional purification system can be upstream or downstream of the displacement purge adsorptive separator. Certain embodiments concern having at least one additional purification system upstream of the displacement purge adsorptive separator, where the separate pretreatment system is configured to remove contaminant components selected from particulates, hydrocarbons having 4 or more carbon atoms, sulfur compounds, water, siloxanes, and combinations thereof. A specific example concerns using a feed source from a biomass digester. Biomass digesters produce a feed gas at substantially ambient pressure comprising a methane fuel component and a carbon dioxide diluent component. Such streams also can comprise potentially additional contaminants or other minor diluent components. For such situations, the system may further comprise a pre-treatment system to substantially remove any contaminant component that may interfere with the adsorptive upgrading of the digester gas stream.

The bulk displacement purge separator may be fluidly coupled to a downstream pressure swing adsorption separator. Such systems may further comprise a compressor upstream of the pressure swing adsorption separator. The compressor may be fluidly coupled to the bulk displacement purge separator to receive and compress an upgraded fluid stream for feed to the pressure swing adsorption device. And tail gas from the pressure swing adsorption device may serve as a feed source for the displacement purge separator.

Another specific example concerns using blast furnace gas as a feed source. Such systems may further comprise a water gas shift module to produce a blast furnace feed gas stream comprising at least a hydrogen fuel gas component and a diluent gas component. This mixture is supplied to the displacement purge bulk separator for adsorption of at least a portion of the diluent gas component on suitable adsorbent materials to produce upgraded fuel gas for downstream further purification by a pressure swing adsorption device.

Another specific embodiment concerns a system comprising a coke oven gas purification device upstream of the displacement purge adsorptive bulk separator. Such systems also optionally can include a pretreatment module for pretreating a coke oven gas feed to substantially remove contaminant components to produce a pre-treated coke oven gas. Again, such systems optionally can include a compressor to compress pre-treated coke oven gas for supply to an adsorption purification device, such as a pressure swing adsorption device.

Another specific implementation concerns a displacement purge adsorptive bulk separation fuel gas upgrading system for hydrogen recovery/CO₂ transfer from an anode exhaust of a high temperature fuel cell, such as a molten carbonate fuel cell, containing low quality hydrogen. Certain disclosed systems comprise a displacement purge adsorptive bulk separator, particularly a rotary adsorption module, having an air side and a hydrogen feed side. The system also includes a fuel cell having an anode and a cathode. The anode is fluidly coupled to a feed inlet for the hydrogen feed side of displacement purge adsorptive bulk separator. The anode provides low quality hydrogen at a relatively low pressure to the displacement purge adsorptive bulk separator. An upgraded hydrogen feed is then provided from the displacement purge adsorptive bulk separator to the anode feed. The cathode is fluidly coupled to the air side of the displacement purge adsorptive bulk separator to receive a fluid stream comprising carbon dioxide.

A method for providing a purified gas product also is disclosed. A particular embodiment of the method comprises providing an embodiment of a disclosed system comprising a bulk displacement purge adsorption separator, one example being a rotary module, that is fluidly coupled to at least one additional fluid stream processing device. The at least one additional fluid stream processing device is either upstream or downstream of the bulk displacement purge separator, and typically is an adsorptive fluid separator, an engine, or both. Feed gas is supplied to the system to produce an upgraded product gas. Additional purification devices also may be included in the system, fluidly coupled to the bulk displacement purge separator, the adsorptive fluid separator, the engine, and any and all combinations thereof. Pressure swing adsorption devices, including rotary and rotary fast cycle devices, are one example of a class of additional adsorptive fluid separators that can be used with the system.

The present embodiments provide several advantages. For example, the feed pressure may be higher than ambient pressure but substantially lower than a corresponding pressure swing adsorption feed pressure. Moreover, energy efficiency may increased by more than 20% compared to a system not utilizing an adsorptive bulk separator. And, gas recovery efficiency, such as fuel gas recovery efficiency, typically is greater than 70%, more typically greater than 85%, in a product stream as compared to the feed. And, diluent gas recovery efficiency typically is greater than 85% in a product stream as compared to the feed.

A substantially pure fuel gas purge stream can be used to reduce non-fuel purge component concentrations in the product stream. For these embodiments, the substantially pure fuel gas purge stream is recovered substantially, such as greater than 95% in the product stream.

Pressure drops in adsorptive fluid systems may be detrimental to the operation of the system. For disclosed embodiments, the pressure drop between feed and product is less than 1 bar, more typically less than 0.5 bar, and even more typically less than about 0.2 bar.

The method may include using purge gas streams substantially free of diluent gas components to be purged from the adsorbent. Multiple purge gases may be used, and purge gas streams can be used substantially simultaneously or sequentially. For certain embodiments, pressure and/or temperature swing processes optionally may be used in addition to a displacement purge process to facilitate desorption of adsorbed diluent on the adsorbent.

One particular embodiment concerns a process for upgrading a methane fuel component of a landfill gas. The landfill gas is produced at substantially ambient atmospheric pressure. At least one separate pre-treatment system can be used to remove a contaminant component or components to produce a methane-fuel-containing landfill gas as the feed stream to an upgrading system. Certain disclosed embodiments use a multi-bed, rotary displacement purge adsorptive separator. For this particular exemplary process, the adsorbent beds preferably comprise parallel passage contactor adsorbent beds comprising at least an activated alumina and/or silica gel adsorbent material suitable to adsorb at least a portion of a carbon dioxide diluent component. And air or oxygen-depleted air often is used as a purge gas to desorb adsorbed carbon dioxide diluent from the adsorbent.

Another particular embodiment concerns producing an upgraded methane fuel gas product. For example, upgraded methane fuel gas can be used as a combustion fuel for natural gas reciprocating engines, such as engines used to generate electrical power in generation installations at landfill gas collection sites.

Another particular embodiment concerns processing a hydrogen fuel gas component and at least one diluent gas component from an anode exhaust gas from a high temperature fuel cell. For these systems, the adsorbent may be an activated carbon-based adsorbent material for adsorbing at least a portion of a carbon dioxide diluent component from the feed gas stream. This process produces an upgraded hydrogen fuel gas product depleted in carbon dioxide relative to the feed gas stream. For this embodiment, the purge gas may be air and/or nitrogen-rich purge gas.

Still another embodiment of the disclosed method processes a feed gas stream by passing it through a conventional flue gas pretreatment module. This is useful for removing contaminant gases that may be present.

Still another embodiment of the disclosed method passes a feed gas stream through a conventional water gas shift module. This converts at least a portion of any carbon monoxide present in the stream into hydrogen fuel gas via the water gas shift reaction.

### BRIEF DESCRIPTION OF THE DRAWINGS

FIG. 1 is a schematic process flow diagram illustrating an embodiment of the present invention comprising a displacement purge adsorptive bulk separation gas upgrading system.

FIG. 2 is a schematic process flow diagram illustrating an embodiment of the present invention comprising a displacement purge adsorptive bulk separation gas upgrading system additionally comprising a downstream adsorptive gas purification system.

FIG. 3 is a schematic process flow diagram illustrating an embodiment of the present invention comprising a displacement purge adsorptive bulk separation gas upgrading system for upgrading and recycling exhausted gas from an upstream adsorptive gas purification system.

FIG. 4 is a schematic process flow diagram illustrating an embodiment of the present invention comprising a displacement purge adsorptive bulk separation gas upgrading system for upgrading a blast furnace or LD Converter/basic oxygen furnace gas.

FIG. 5 is a schematic process flow diagram illustrating an embodiment of the present invention comprising a displacement purge adsorptive bulk separation gas upgrading system for upgrading and recycling exhausted gas from an upstream coke oven gas purification system.

FIG. 6 is a schematic process flow diagram illustrating an embodiment of the present invention comprising a displacement purge adsorptive bulk separation gas upgrading system for hydrogen recovery/CO₂ transfer from anode exhaust of an MCFC containing low quality H₂.

### DETAILED DESCRIPTION

In view of the many possible embodiments to which the principles of the disclosed invention may be applied, it should be recognized that the illustrated embodiments exemplify the invention and do not limit the scope of the invention. For example, the present invention is exemplified with reference primarily to gas mixtures comprising at least one fuel component and at least one diluent. Exemplary fuel gases include hydrogen and methane. Additional examples of gases, without limitation, that desirably may be recovered by practicing disclosed embodiments include nitrogen, helium, ammonia synthesis gas (hydrogen and nitrogen) and synthesis gas (hydrogen and carbon monoxide). Examples of diluents that may be included with such gas mixtures include carbon monoxide, carbon dioxide, hydrocarbons, water, ammonia, hydrogen sulfide, and combinations thereof. Thus, a person of ordinary skill in the art will appreciate that gas mixtures other than those comprising a fuel gas, and gas mixtures other than those particularly disclosed herein, also can be processed according to the disclosed embodiments.

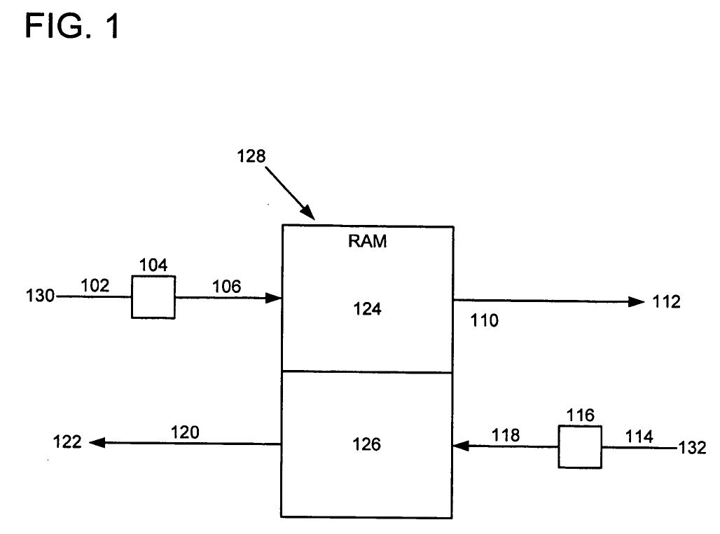

FIG. 1 depicts a first embodiment of a displacement purge adsorptive bulk separation gas upgrading system 100. Feed gas stream 102 is from feed gas source 130 to adsorptive bulk separator 128 through feed blower 104 and feed gas conduit 106. Adsorptive bulk separator 128 comprises multiple adsorbent beds, two such adsorbent beds 124 and 126 being illustrated in FIG. 1. Adsorbent beds 124, 126 comprise adsorbent material suitable for adsorptive separation of at least a portion of a diluent (e.g. non-fuel gas) component of the feed gas stream 102 from a desired component, such as a fuel gas component, of the feed gas. The adsorbent material in adsorbent beds 124 and 126 may be selected from those materials known in the art, or developed subsequently, that are suitable for removing components, such as diluents, to produce an upgraded gas. For example, such adsorbent materials include those suitable to preferentially adsorb carbon dioxide gas in the presence of methane gas, to produce an upgraded fuel gas product 112, which is relatively depleted in carbon dioxide relative to the feed gas 102, and preferably relatively enriched in the desired methane fuel gas component relative to the feed gas 102. Exemplary such adsorbent materials comprise molecular sieve materials (including natural and synthetic zeolites and titania based materials), activated carbons, carbon molecular sieves, alumina- and/or silica-based materials, and functional-impregnated adsorbent materials, such as amine-impregnated adsorbents. A person of ordinary skill in the art will appreciate that the adsorbent beds 124, 126 also may include more than one adsorbent material, any other material useful for facilitating desired processes, such as dessicants, carbon oxide removing materials, such as alumina, activated carbon-based adsorbents and silica, zeolites, and any and all combinations of such materials. Furthermore, the materials may be part of an integrated adsorber element, or may provided in separate adsorber elements positioned to serially receive the fluid mixture provided by feed gas 102.

Feed gas conduit 106 supplies feed gas 102 to the adsorptive separator 128, for supply to adsorbent bed 124 during an adsorption step wherein at least a portion of the diluent component of the feed gas 102 is adsorbed on the adsorbent material in adsorbent bed 124 to provide upgraded fuel gas product 112. Upgraded fuel gas product 112 may be supplied from the adsorptive separator 128 by product gas conduit 110 for use by a downstream fuel gas user. Subsequent to the adsorption step described above, the adsorbed diluent gas component is substantially desorbed from adsorbent bed 126 by means of displacement purge by purge gas stream 114 supplied to the adsorptive bulk separator 128 from purge gas source 132 through purge blower 116 and purge gas conduit 118. Exhaust gas stream 122 comprising desorbed diluent gas component and displacement purge gas 114 exit the adsorptive bulk separator 128 through exhaust gas conduit 120.

Feed gas source 130 may be any suitable source of a feed gas stream 102 comprising at least a desired gas component, and an undesired diluent gas component. Preferred feed gas sources include biogas sources, and more particularly may comprise landfill gas and/or digester gas, such as anaerobic digester gas, which typically comprise at least a methane fuel gas component, and a carbon dioxide diluent component. In such a case, the inventive adsorptive bulk separation fuel gas upgrading system of FIG. 1 preferably may remove at least a portion of the carbon dioxide diluent component from the feed gas 102 by adsorption to produce an upgraded fuel gas product 112.

Feed gas streams also may comprise more than one diluent gas component. At least a portion of multiple such diluent gas components may be adsorptively removed from the feed gas stream by the adsorptive bulk separation upgrading system to deliver an enriched fuel gas component. For example, in a particular landfill gas fuel gas stream, both water and carbon dioxide diluent components may be adsorptively separated from the fuel gas component to yield an enriched fuel gas product stream.

Purge gas source 132 may be any suitable source of a purge gas stream 114. Purge gas stream 114 preferably is substantially free of the diluent gas component desired to be purged from the adsorbent beds 124, 126, and is preferably suitable to substantially desorb the adsorbed diluent gas component from the adsorbent beds 124, 126 by means of a displacement purge process. In alternative versions of the present embodiment, pressure and/or temperature swing processes may be utilized in addition to the displacement purge process to facilitate desorption of adsorbed diluent gas on the adsorbent material in the adsorbent beds 124, 126. Typical examples of purge gas streams 114 include those comprising air, oxygen depleted air (such as combustion products and/or flue gas mixtures), oxygen, substantially inert gases, such as predominantly nitrogen gas mixtures (such as generated nitrogen and/or nitrogen enriched gas mixtures), predominantly argon mixtures, steam, enriched fuel gas, and any and combinations thereof. Such purge gas streams additionally may be used sequentially. Further, purge gas streams may comprise other gas components external to the adsorption system wherein such purge gas components are substantially less adsorbed on the adsorbent material than the diluent gas component.

In the process of desorbing adsorbed diluent gas from the adsorbent beds 124, 126 by displacement purge, a portion of the displacement purge gas 114 may be retained in the adsorbent beds 124, 126, and may become entrained in the upgraded fuel gas product 112 produced by the adsorptive bulk separator 128 during the subsequent adsorption step. For this reason, it is desirable that compatibility with the intended downstream use of the upgraded gas product 112 be considered as a factor when selecting a suitable purge gas 114 composition and corresponding purge gas source 132. In situations where entrainment of a non-fuel purge gas specie or species which may be retained in the adsorbent beds in the product gas is desirably minimized, fuel gas may be used as a purge gas component.

Feed blower 104 is preferably a high efficiency, low pressure blower suitable for supplying feed gas stream 102 to the adsorptive separator 128 at a suitable operating pressure, such as a pressure of from about 1 to about 10 psig, and more particularly from about 1 to about 3 psig, with a minimum of energy consumption and capital cost, particularly in comparison with a high pressure compressor. Similarly, purge blower 116 is preferably also a low cost (capital and operating) low pressure blower that supplies purge gas stream 114 to the adsorptive separator 128 at a suitable operating pressure, such as a pressure of from about 1 to about 3 psig. In such examples of the present embodiment, the displacement purge adsorption process utilized in the adsorptive separator 128 to upgrade a fuel gas may be carried out at substantially the ambient pressure of the feed gas 102 as supplied from the feed gas source 130, thereby minimizing any compression and expansion costs and/or losses of the adsorption system, resulting in an economically advantageous system for upgrading fuel gas.

In an exemplary application of the present embodiment of the displacement purge adsorptive bulk separation system for upgrading fuel gas described above, the inventive system may be used to upgrade the methane fuel component of a landfill gas produced at substantially ambient atmospheric pressure from a landfill gas collection installation in a solid waste landfill. In such a landfill gas collection installation, collected landfill gas may in large part comprise a methane fuel component and a carbon dioxide diluent component, in addition to potential other contaminant or minor diluent components. At least one separate pre-treatment system, examples of which are known in the art, optionally may be used to remove any contaminant components (such as particulates, heavy hydrocarbons [4 or more carbon atoms], sulfur compounds, significant water vapor, siloxanes) of the landfill gas which may interfere with the adsorptive upgrading of the gas stream, to produce a methane-fuel-containing landfill gas, that may be supplied to the present inventive upgrading system as feed gas 102. In such a case, the displacement purge adsorptive separator 128 preferably comprises a multi-bed, rotary displacement purge adsorptive separator as described above and known in the art. The adsorbent beds 124, 126 preferably may comprise parallel passage contactor adsorbent beds comprising at least an activated alumina and/or silica gel adsorbent material suitable to adsorb at least a portion of the carbon dioxide diluent component of the landfill feed gas 102. Air or oxygen-depleted air may be used as a purge gas 114 to desorb adsorbed carbon dioxide diluent from the adsorbent beds 124, 126 by displacement purge to form exhaust stream 122.

A specific exemplary instance of the above described landfill gas upgrading application of the present invention may be applied to produce an upgraded methane fuel gas product for combustion fuel use in natural gas reciprocating engines used to generate electrical power in generation installations at existing and particularly aging landfill gas collection sites. Such natural gas engines typically are designed to run on as-extracted landfill gas compositions as fuel when such generation installations are first installed. As a landfill site ages, the relative concentration of the methane fuel gas component of the landfill gas stream decreases due to changes in the landfill decomposition and landfill gas collection system. As a result, the operation efficiency and even feasibility of the natural gas reciprocating engines typically decreases over time as the fuel gas composition of the landfill gas worsens, such that continued operation of the generation installation may become impractical or uneconomical. The above described displacement purge adsorptive bulk separation system may be employed to increase the concentration of the methane fuel gas component and/or the BTU value, or heating value in an upgraded landfill fuel gas product, such that the operation of the existing natural gas reciprocating engine generation installation may again be practical, using the upgraded landfill gas fuel product as fuel. The above described displacement purge adsorptive separation system may prove advantageous for the present exemplary instance over other known systems potentially capable of upgrading an aging landfill gas stream due to the efficiency of the described displacement purge adsorptive separator operating at substantially ambient pressure.

In a second application of the present embodiment of the displacement purge adsorptive bulk separation system for upgrading fuel gas described above, the inventive system may be used to upgrade the methane fuel component of a digester gas produced as a product of a biomass digester, such as an anaerobic digester. In such a biomass digester, a digester gas may be produced at substantially ambient pressure that may comprise a methane fuel component, a carbon dioxide diluent component and potentially additional contaminant or other minor diluent components. Following optional pretreatment of the digester gas if necessary with a known pre-treatment system to substantially remove any contaminant component that may interfere with the adsorptive upgrading of the digester gas stream, the resulting digester gas may be supplied to the inventive system as a digester feed gas 102 for separation to produce an upgraded fuel gas product 112. This process may be performed using substantially similar adsorbent materials and preferred adsorptive separator 128 configuration as the landfill gas application described above.

In a further exemplary application of the presently described embodiment of the inventive adsorptive bulk separation system, a feed stream comprising a hydrogen fuel gas component and at least one diluent gas component may be supplied as feed gas stream 102 for adsorptive upgrading by displacement purge bulk separation in the inventive system. Exemplary such suitable hydrogen-containing feed gas streams may comprise anode exhaust gas from a high temperature fuel cell, such as a molten carbonate or solid oxide fuel cells, wherein the anode exhaust stream may comprise at least a hydrogen fuel gas component and a carbon dioxide diluent gas component. In such an application, activated carbon-based adsorbent material may be preferentially utilized in the adsorbent beds of the adsorptive separator to adsorb at least a portion of the carbon dioxide diluent component from the feed gas stream, to produce an upgraded hydrogen fuel gas product depleted in carbon dioxide relative to the feed gas stream. In such an application, an air and/or nitrogen-rich purge gas are examples of purge gases that may be preferably used to desorb adsorbed diluent component gas from the adsorbent beds 124, 126 by displacement purge.

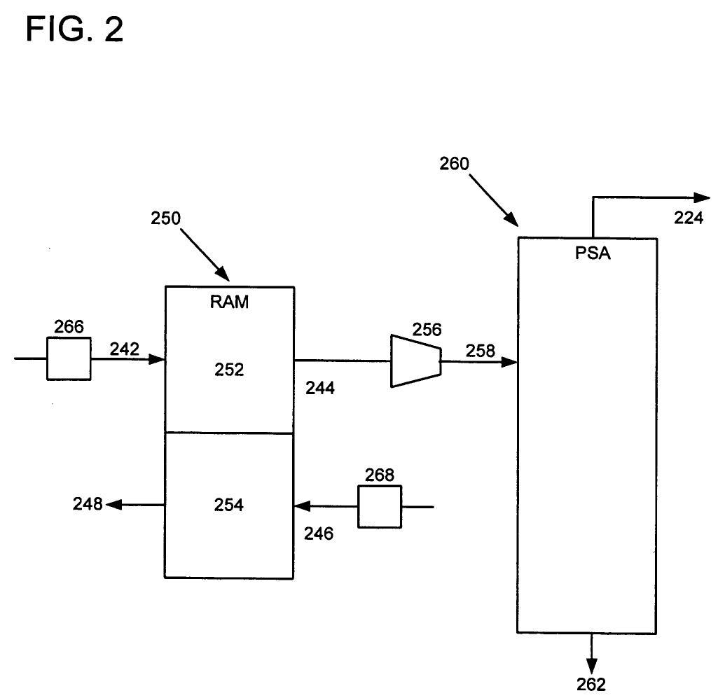

Referring now to FIG. 2, depicting an embodiment of the present invention comprising a displacement purge adsorptive bulk separation system and a downstream adsorptive purification system, a feed gas stream 242, typically comprising at least a fuel gas component and a diluent gas component, is supplied through feed blower 266 to the displacement purge adsorptive separator 250, for adsorption of at least a portion of the diluent gas component in adsorbent beds 252, 254 to produce upgraded gas product 244. Essentially similar to the displacement purge adsorptive separator described above in reference to FIG. 1, the adsorbed diluent gas component in adsorbent beds 252, 254 in separator 250 is preferably desorbed by displacement purging using purge gas stream 246 supplied through purge blower 268.

In the present embodiment depicted in FIG. 2, upgraded gas product 244 is supplied to adsorptive purification system 260 through upgraded feed compressor 256 as compressed upgraded feed gas 258. The adsorptive purification system 260 is operable to purify upgraded feed gas 258 to remove at least a portion of remaining non-desired components, such as non-fuel gas components, of the upgraded feed, to produce purified gas product 264 and a desorption waste stream 262. For fuel gas embodiments, adsorptive purification system 260 may be configured to adsorb substantially all non-fuel gas components of upgraded feed gas 258 to produce a purified fuel gas product 264 that is substantially pure from non-fuel gas components. An advantage of the present embodiment is that by combining the displacement purge adsorptive separator and adsorptive purification systems in the above referenced manner, the compressive load (and energy and compressor size) required to compress the purification system feed to produce a given volume of purified gas may be reduced due to the reduced concentration of diluent gas component(s) in the purification system feed gas, which must be compressed.

In an exemplary application of the present embodiment, the feed gas stream 242 may comprise landfill gas similar to that described above in reference to FIG. 1, wherein the landfill gas may comprise at least a methane fuel gas component and a carbon dioxide diluent component. In such a case, the displacement purge adsorptive bulk separator 250 desirably may remove at least a substantial portion of the carbon dioxide component from the feed gas stream 242 by adsorption on adsorbent beds 252, 254, which is then desorbed from beds 252, 254 by means of displacement purge by purge gas 246 to produce exhaust gas 248. The resulting upgraded fuel gas 244 is then relatively depleted in carbon dioxide relative to the feed landfill gas 242, and may then be more efficiently compressed by upgraded feed gas compressor 256 than an equivalent fuel-gas containing volume of initial landfill feed gas 242 to produce compressed upgraded feed gas stream 258. The adsorptive purification system 260 is preferably a pressure swing adsorption system, operable to substantially purify the methane fuel gas component of remaining carbon dioxide, and potentially other remaining non-fuel gas components of feed gas stream 258, to produce substantially purified fuel product gas 264 for use in high-purity fuel gas applications downstream. The use of a substantially ambient pressure displacement purge adsorptive bulk separation system to upgrade the fuel gas prior to purification of the fuel gas by PSA 260 may provide cost savings relative to the conventional use of PSA 260 alone to produce a purified fuel gas product by reducing the compression requirements for compressing the upgraded fuel gas from the bulk separation system compared to initial landfill gas comprising additional carbon dioxide. Alternatively, another feed gas comprising a methane fuel gas component and a carbon dioxide diluent gas component, such as another biogas (such as digester gas and particularly anaerobic digester gas), may be used in the above application in place of landfill gas.

Alternatively in the above application, a feed gas comprising at least a hydrogen fuel gas component and a carbon dioxide diluent component may be used in the present system embodiment to produce purified hydrogen gas product 264. Suitable such hydrogen-containing feed gases may comprise high temperature fuel cell anode exhaust gas, such as that from molten carbonate or solid oxide fuel cells. In such a case, the combined adsorptive bulk separation and purification system of the present embodiment may be desirably used to produce a purified hydrogen fuel product from an anode exhaust gas from a high temperature fuel cell. The purified hydrogen fuel product is suitable for storage or immediate use as fuel, such as in proton exchange membrane (PEM) or other fuel cells, or other hydrogen powered engines, such as hydrogen internal combustion engines.

Further, alternatively in any of the above applications of the present embodiment of the invention, PSA exhaust 262 may be recovered back to an inlet of adsorptive separator 250, or instead, a vacuum pump may be used to withdraw PSA exhaust 262 and it may be recovered back to an inlet of the PSA compressor 256. In such a manner, fuel gas component recovery may be desirably enhanced.

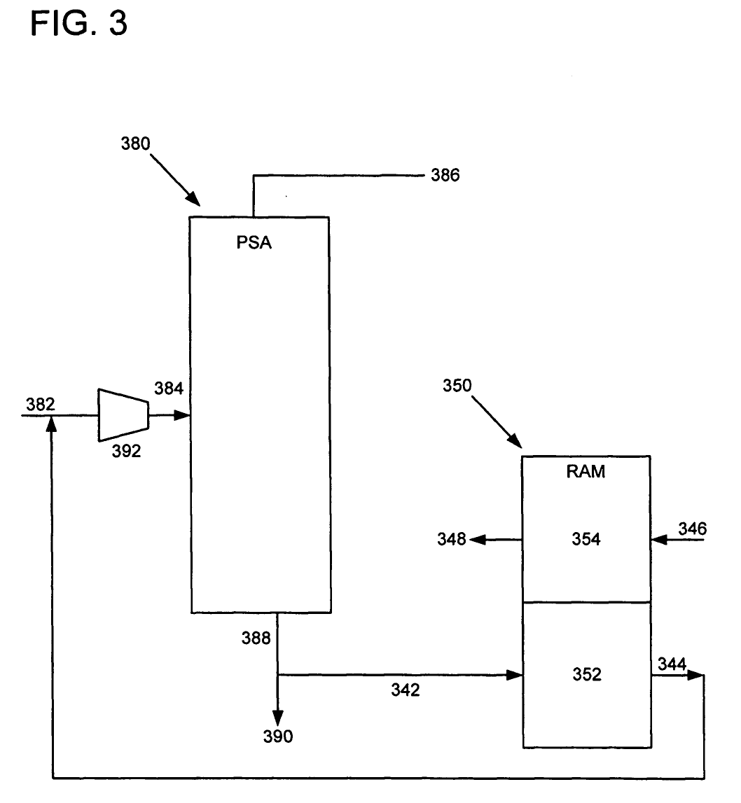

FIG. 3 depicts an embodiment of the present invention comprising a displacement purge adsorptive bulk separation system and an upstream adsorptive purification system. A displacement purge adsorptive bulk separator 350 is configured to receive a portion of the gas (tailgas) 388 of an upstream adsorptive gas purification system 380, as tailgas feed stream 342 for separation in the displacement purge adsorptive bulk separator 350. In this embodiment, the adsorptive purification system 380 is preferably a pressure swing adsorption system operating to purify a gas stream, exemplified by fuel feed gas stream 382. Feed gas stream 382 typically comprises at least a desired fuel gas component and a diluent gas component. In the PSA system 380 the desired fuel gas component is substantially purified to produce purified fuel gas product 386, by substantial adsorption of non-fuel components of fuel gas feed stream. Adsorbed non-fuel components are subsequently desorbed by purging with a portion of purified fuel gas product 386 to form PSA exhaust gas 388, comprising at least a fuel gas component and a diluent gas component. Therefore, one function of the adsorptive bulk separator 350 in the present embodiment is to receive a portion of PSA exhaust gas 388 as tailgas feed stream 342 and to adsorb at least a portion of the diluent gas component in adsorbent beds 352, 354, thereby producing upgraded tailgas product 344. The remaining portion of PSA tailgas 388 is discharged as PSA waste gas 390 in part to prevent the accumulation of any gas component in the PSA exhaust gas 388 within the displacement purge bulk separation system loop recycling back to the PSA feed. Upgraded tailgas product 344 may be recycled for combination with fuel feed gas stream 382 prior to compression in PSA feed compressor 392 and supply to the PSA 380 as compressed PSA feed gas 384. Such upgraded tailgas product 344 comprises a portion of the fuel gas component that was lost in the PSA process as part of PSA exhaust gas 388, returning such portion of fuel gas to the PSA 380 for additional separation, thereby advantageously increasing recovery of the fuel gas component from the fuel feed gas 382 achieved by the PSA system 380, and the useful portion of the fuel gas component that may be delivered as desired purified fuel gas product 386. Following adsorption of at least a portion of the diluent gas component from the tailgas feed stream 342 in adsorbent beds 352, 354, the adsorbed diluent gas is desorbed by means of displacement purge by purge gas 346 to form purge exhaust 348.

By using the above disclosed displacement purge adsorptive bulk separation system operating at substantially the ambient pressure of the PSA exhaust gas 388, the present embodiment may enhance gas recovery performance of the adsorptive purification system 380 without requiring additional potentially costly auxiliary compression machinery.

In an exemplary application of the present embodiment, fuel feed gas stream 382 may comprise hydrogen reformate from a fuel reformer, such as a steam methane reformer, or other catalytic hydrogen reformer. Adsorptive purification system 380 preferably may be a hydrogen purification PSA 380, in which case the fuel feed gas stream comprises at least a hydrogen fuel gas component and a carbon dioxide diluent gas stream, which may be purified by PSA to produce purified hydrogen product gas 386 and desorbed PSA exhaust gas 388. In such case, the PSA exhaust gas 388 may comprise at least a hydrogen fuel gas component and a carbon dioxide diluent gas component. The displacement purge adsorptive bulk separation system may adsorb at least a portion of the carbon dioxide diluent gas component to produce an upgraded hydrogen tailgas product 344 for return to the PSA feed stream 384. In this exemplary application, the displacement purge adsorptive bulk separator 350 preferably is configured for hydrogen upgrading and carbon dioxide adsorption, including suitable adsorbent material for adsorbing carbon dioxide diluent gas, and may preferably comprise a rotary adsorption apparatus with multiple, parallel passage adsorbent beds, as described in more detail above in reference to FIG. 1.

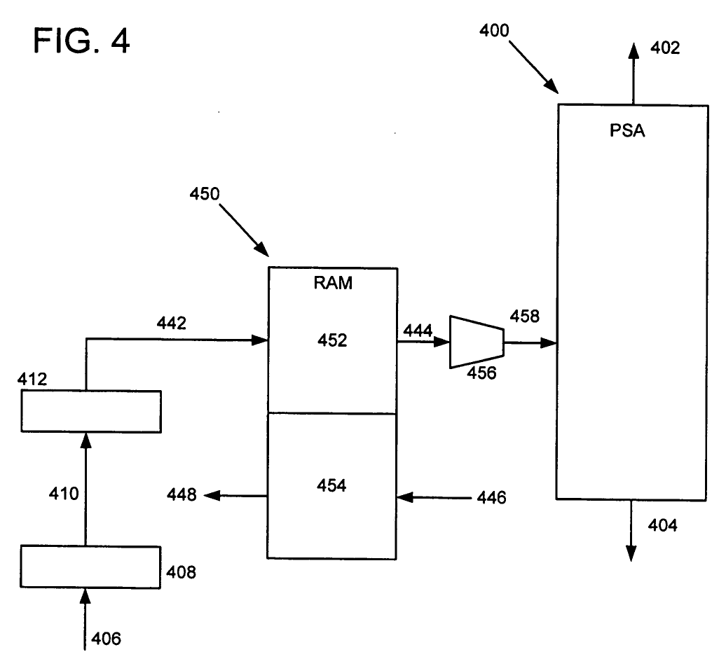

FIG. 4 depicts a displacement purge adsorptive bulk separation system and an upstream fuel gas source, such as a steel making furnace offgas fuel source, and more particularly a blast furnace flue gas, or basic oxygen furnace (BOF)/LD (Linz-Donawitz) converter combustion gas. A displacement purge adsorptive bulk separator 450 is configured to receive a blast furnace, BOF and/or LD converter feed gas 406 as fuel containing feed gas stream 442 for upgrading to upgraded fuel gas product 444 by adsorptive bulk separation. In a first application of the present embodiment of the invention, flue gas from the top of a steel-making blast furnace may be supplied to the inventive system as blast furnace flue gas 406. Such blast furnace flue gas 406 typically comprises a fuel component (typically comprising carbon monoxide and hydrogen gas), a diluent component (typically comprising carbon dioxide and/or nitrogen gas), and potentially a contaminant component, thereby potentially requiring pretreatment (such as by scrubbing and/or particulate removal) in a conventional flue gas pretreatment module 408 to substantially remove the contaminant gas (and/or particulate) component, leaving pretreated blast furnace gas 410.

Following such conventional pre-treatment (if required) the pretreated blast furnace gas 410 may be passed through a conventional water gas shift module 412 to convert at least a portion of the carbon monoxide fuel gas in the pretreated blast furnace gas stream 410 into hydrogen fuel gas via the water gas shift reaction, thereby producing blast furnace feed gas stream 442. Blast furnace feed gas 442, comprising at least a hydrogen fuel gas component and a diluent gas component, may be supplied to displacement purge bulk separator 450, for adsorption of at least a portion of the diluent gas component on suitable adsorbent materials in adsorbent beds 452 and 454, to produce upgraded fuel gas product 444 for downstream use, or for downstream further purification, such as by purification PSA 400. Following adsorption of diluent component in adsorbent beds 452 and 454, such diluent component may be substantially desorbed by means of displacement purge using purge gas 446, to produce purge exhaust gas 448, which may be disposed, or utilized for other purposes.

In the case where further purification of upgraded fuel product gas 444 is desired for downstream use, upgraded fuel gas product 444 may be compressed in PSA feed compressor 456 for supply to purification PSA 400 as compressed fuel feed gas 458. Such purification PSA 400 may then further purify compressed fuel feed gas 458 by a PSA process or processes to form purified fuel product 402 for supply to downstream high-purity fuel applications. PSA tail gas 404 may be disposed or used for other purposes. In such an embodiment, the reduction in the quantity of diluent gas component present in the PSA fuel feed gas 458 due to adsorptive bulk separation of the diluent component in displacement purge separator 450 may desirably reduce the required size and energy consumption of the PSA feed compressor 456 and purification PSA 400 in order to produce a given quantity of purified fuel product gas 402. Further, since the displacement purge separator 450 may be operated at or near the ambient pressure of the blast furnace flue gas supply, no additional compression is required to upgrade the blast furnace gas prior to the PSA, providing an economically advantageous reduction in total energy consumption required to produce the purified fuel product 402.

In a second application of the present embodiment, LD converter/BOF feed gas comprising at least a fuel gas component, a diluent gas component, and potentially a contaminant component may be supplied to the inventive system as BOF feed gas 406. Feed gas 406 may be pretreated, shifted, upgraded and preferably purified to form purified fuel gas product 402, similar to the first application utilizing Blast Furnace flue gas feed.

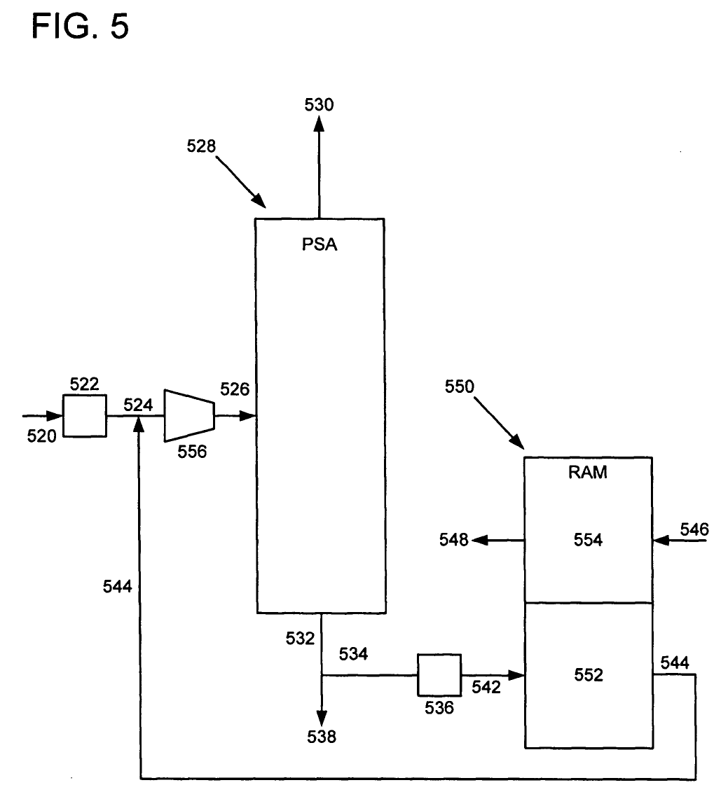

FIG. 5 depicts a displacement purge adsorptive bulk separation system and an upstream coke oven gas purification system. Displacement purge adsorptive bulk separator 550 is configured to receive a portion 542 of tailgas 532 of coke oven gas purification PSA 528. PSA 528 receives coke oven feed gas 520 extracted from a metallurgical coke oven. Tailgas feed stream 542 is provided to separator 550 for separation from a coke oven gas 520 extracted from a metallurgical coke oven. Coke oven feed gas 520 typically comprises a desired hydrogen fuel gas component, a diluent component (typically comprising methane and carbon monoxide and/or carbon dioxide), and potentially a contaminant component, in which case coke oven gas 520 may preferably be pre-treated in conventional pre-treatment module 522 to substantially remove the contaminant component, thereby producing pre-treated coke oven gas 524. Pre-treated coke oven gas 524 may then be compressed by PSA feed compressor 556 to produce compressed coke oven feed gas 526 for supply to coke oven gas purification PSA 528. PSA 528 preferably produces substantially purified hydrogen product gas 530 by a suitable PSA process, and PSA tailgas 532, typically comprising hydrogen, methane and further diluent components. A portion of PSA tailgas 534 may be post-reformed (preferably including water gas shift reaction of reformate gas) in post-reformer 536 to produce tailgas reformate 542 comprising at least a fuel gas component (typically primarily hydrogen) and a diluent component (typically comprising carbon dioxide) suitable for feed to displacement purge adsorptive bulk separator 550 for bulk separation. A further portion of PSA tailgas 532 may be disposed as PSA exhaust gas 538, to prevent buildup of any exhaust gas components in the tailgas recycle system.

Adsorptive bulk separator 550 is configured to adsorb at least a portion of the diluent component (typically primarily carbon dioxide) of tailgas reformate 542 by adsorption on suitable known adsorbent material in adsorbent beds 552 and 554, to produce upgraded tailgas stream 544. Tailgas stream 544 is enriched in the fuel gas component (typically hydrogen) for recycle into pre-treated coke oven feed gas 524 for feed to purification PSA 528. The portion of the diluent gas component adsorbed in adsorbent beds 552 and 554 may then be substantially desorbed by means of displacement purge by purge gas stream 546 to produce purge exhaust gas 548, which typically may be disposed.

In the above embodiment, the recovery of the fuel gas component from the coke gas feed for purification and supply as purified product 530 may be enhanced by using displacement purge adsorptive bulk separator 550, to recycle upgraded fuel gas component from the PSA tailgas 532 for further purification in the PSA 528. Further, as the displacement purge adsorptive bulk separator 550 preferably operates at or near the ambient pressure of the PSA tailgas 534 and tailgas reformate 542 streams without additional compression required, the fuel component recycle system disclosed in the present embodiment may provide desirable economic advantages relative to a potential conventional PSA tailgas separation and recycle system.

### EXAMPLES

The following examples are provided to illustrate certain features of the disclosed embodiments. A person of ordinary skill in the art will appreciate that the scope of the present invention is not limited to these exemplary features.

### Example 1

This example concerns upgrading low BTU LFG (landfill gas) for use in a natural gas engine. It refers to features exemplified by FIG. 1. The system and process described in this example are useful to improve and extend the operation of landfill gas engines through landfill gas processing. The system and process of this example efficiently and economically upgrades the methane content of aging landfill gas by removing carbon dioxide.

Typical landfill gas comprises 55% CH₄, 35% CO₂, and 10% N₂. In most locations, this gas cannot be released directly into the atmosphere; it must be burned. Thus, when burning landfill gas is beneficial or economically favorable, this gas can be burned in natural gas engines to generate electricity. Typically, however, the CO₂ content of the produced gas increases over the lifetime of the landfill while the CH₄ content decreases. Such reduced CH₄ content landfill gas is referred to as ‘aging LFG.’ This decreases the energy per unit volume of produced gas. i.e., the BTU content of the LFG decreases over the life of the landfill. At ratios of CH₄:CO₂ below 0.65:1, the landfill gas cannot be efficiently burned in an engine.

A device operating in the following manner, according to the features exemplified in FIG. 1, can efficiently and economically upgrade the methane content of aging landfill gas by removing carbon dioxide. Aging landfill gas 130 enters the device and CO₂ is preferentially adsorbed over CH₄. Product 112 is enriched in CH₄. Air is used as countercurrent purge 132 to remove adsorbed CO₂, and the feed step repeats. While some air is entrained in the product, this is acceptable since the CH₄ is mixed with from about 1.3 to about 1.6 times stochiometric air in the engine prior to combustion. A typical adsorbent is activated alumina and/or silica gel.

The overall benefits of this device include: (1) increasing the methane-to-CO₂ ratio to greater than 1 (like typical fresh landfill gas); (2) increasing or improving the BTU content by removing CO₂ and enriching the CH₄ content by using low pressure displacement purge device; (3) turning low BTU gas into med/high BTU gas more suitable for combustion; (4) reducing landfill gas variability over the operating life of the landfill; and (5) extending the useful life of landfill gas engines, thereby improving the economic prospects of a new installation, such as by improving or extending electricity generation from landfills. Table 1 provides information concerning composition of fresh LFG, aging LFG, and upgraded LFG product composition.

The technological benefits of the embodiment discussed in this example arise from the benefits of using displacement purge technology and include: (1) operation at low pressure (3-4 psig); (2) having a low pressure drop (1-2 psi); (3) using blowers instead of expensive compression equipment; (4) having low operating costs because blowers require less energy to operate compared to compression equipment; (5) having lower capital costs compared to those of a typical PSA since the displacement purge device operates at low pressure and does not require pressure vessels; (6) having a CH₄ recovery of 85-90%; and (7) using 40% of the power (includes blowers, air dryer, etc.) compared to conventional PSA for the same CH₄ recovery.

TABLE 1

| | ‘Fresh’ LFG | Aging LFG | Upgraded LFG/Product |
|---|---|---|---|
| CH₄ | ~50-60% | ~35% | ~40-42% |
| CO₂ | ~30-40% | ~55% | ~32-40% |
| N₂ | ~0-10% | ~10% | ~18-23% |
| O₂ | ~0-2% | ~2% | ~0-3% |
| CH₄:CO₂ | ~(1.25-1.5):1 | ~0.65:1 | Minimum 1:1 CH₄:CO₂ |

### Example 2

This example concerns hydrogen purification/export from an MCFC (molten carbonate fuel cell) using a rotary adsorption module (RAM) with reference to features exemplified by FIG. 2. Anode exhaust of an MCFC (molten carbonate fuel cell) typically contains 20-40% H₂ at very low pressure (˜15 psia). This stream is typically burned and the CO₂ recovered to the cathode inlet. As a result, it is desirable to find an economical way to purify the stream for export in order to obtain some value from this waste hydrogen. Since the anode exhaust is at low pressure and is of low quality, a conventional PSA system is typically used to achieve high purity H₂ for export. Typical flow from a IMW MCFC can produce about 100 kg/day of pure H₂.

However, since the MCFC is functioning as a power plant, it is desirable to use as little energy as possible to purify H₂. Thus a unique and novel two-stage separation system is proposed as an improvement over conventional PSA technology.

The proposed system will consist of (1) a bulk separation rotary adsorption module (RAM) in series with (2) a hydrogen purification PSA. The bulk separation device will operate at low pressure and will function to remove the bulk of the CO₂ from the DFC exhaust. The hydrogen PSA will operate at higher pressure and will produce a purified hydrogen product.

The RAM (1) functions to remove the bulk of the CO₂ from the anode exhaust stream, and (2) utilizes external purging instead of pressure-swing for adsorbent regeneration. The benefits of the bulk separator include (1) achievable recovery of over 90% of H₂, and (2) operation at near atmospheric pressure with a low pressure drop. The RAM utilizes fast-cycle adsorption technology, structured adsorbent beds and rotary valve technology. It further incorporates multiple adsorbent types and layers each having high capacity and selectivity over hydrogen for the contaminants in the anode exhaust.

The bulk separation rotary adsorption module benefits the overall system. For example, the bulk separation rotary adsorption module (1) increases the H₂ purification PSA recovery by enriching the H₂ concentration of the anode exhaust; (2) decreases the H₂ purification PSA required operating pressure from about 500 psig to about 150 psig, significantly reducing the operating and capital costs of the system; and (3) reduces the volume of gas processed by purification PSA by over 60%, significantly reducing the compression and size of the PSA operating and capital costs of the system. The bulk separation adsorber operates at <3 psig and requires minimal operating energy compared to the PSA process, and the fast-cycle structured adsorbent bed and rotary valve technology increases the unit productivity per unit volume, thus enabling a small, efficient bulk separation device.

One consequence of utilizing external purge to regenerate the adsorbent bed is that some purge gas may be entrained in the enriched hydrogen product. However, in this example the purge gas may be nitrogen, which do not affect the downstream purification PSA's ability to meet purity or operate with high recovery.

The H₂ purification PSA functions to remove the remaining contaminants (CO₂, CO, and N₂) and create a purified hydrogen stream meeting or exceeding the required purity specifications. The system operates at about 150 psig, and uses integrated rotary valves and beaded adsorbents. The rotary valves replace banks of solenoid-actuated valves in conventional PSA technology, reducing the cost and complexity of the system. Further, the PSA may use multiple adsorbent types and/or layers, each having high capacity and selectivity over hydrogen for the contaminants in the anode exhaust to efficiently produce a purified hydrogen stream.

A conventional H₂ PSA has an operating pressure of 500 psig and an H₂ recovery of 75%. Exemplary dual system embodiment of the present invention used for comparison has (1) a bulk separator having an operating pressure of 17 psia, and (2) an H₂ purification PSA having an operating pressure of 150 psig and an overall H₂ Recovery of 75%. As shown in Table 2 below, the bulk separator H₂ Recovery is 91%, and the H₂ purification PSA H₂Recovery is 83%.

Table 2 summarizes the purity of the anode exhaust as it passes through the two-stage separation system.

TABLE 2
Purity of Anode Exhaust Gas at Each Stage of Two-Stage System

| | | Bulk Separator | Purification PSA |
|---|---|---|---|
| | Anode Exhaust | Product | Product* |
| H₂ | 18% | ~50% | 98% min |
| CO₂ | 72% | ~25% | <100 ppm |
| N₂ | 1% | ~25% | <2% |
| CO | 1% | ~3% | <1 ppm |
| H₂O | 6% | <100 ppm | <100 ppm |
| Pressure | 0.2 | 2-3 | 150 |
| (psig) | | | |
| H₂ Recovery | — | ~91 | ~83 |
| (%) | | | |

Some performance enhancements include (1) a ˜50% reduction in H₂ purification power requirements over conventional PSA; (2) a ˜40% decrease in overall H₂ production costs over conventional PSA; and (3) a ˜25% decrease in capital costs. Further benefits of the dual stage system include: (1) all waste streams can be recovered to the cathode or burned for heat production; (2) the combined bulk separator and conventional PSA systems uses less energy than the conventional PSA alone (achieving a net reduction in required purification power by about 40%); (3) the volume of gas processed by the purification PSA is decreased by ˜50%, which (4) decreases the compression energy required by the conventional PSA by approximately 40%, and (5) decreases the conventional PSA size as well as the compressor size required to operate the PSA. Additionally, the waste stream from both the displacement purge device and the purification PSA are recovered back to the cathode inlet to maintain CO₂ balance in the system.

### Example 3

This example concerns the recovery of hydrogen from PSA exhaust gas. It refers to features exemplified by FIG. 3.

Typical SMR H₂ purification PSA's operate between 200-350 psig and achieve 75-90% H₂ recovery for a high purity (99.99+% and less than 10 pp CO+CO₂) H₂ product. The PSA exhaust contains 20-45% H₂ and some CH₄ and CO at low pressure (typically <10 psig). Hydrogen, methane and carbon monoxide can be recovered from the PSA exhaust, which is then fed to a PSA system for re-purification or returned to the reformer feed.

The operating principle of this embodiment includes the following features: (1) the feed 382 to the purification PSA is the product of a reformer, typically SMR; (2) the PSA removes CO₂ and CO from the feed, and produces purified H₂ product 386; (3) the PSA exhaust 388 is fed to the RAM at low pressure (5-10 psig) and contains 20-45 % H₂; (4) a fraction of the exhaust 342 is sent to the displacement purge for upgrading, and a fraction 390 is sent to waste; (5) the displacement purge device removes CO₂ from the exhaust and enriches the H₂ content of the exhaust 344; and (6) waste stream 390 is purged from the system to prevent the build up of N₂ or CO or any other component in the recirculation loop.

The overall benefits of this embodiment include: (1) an increase in the overall H₂ recovery by from about 5% to about 15%; (2) recovery of from about 70% to about 90% of the H₂ from the PSA exhaust; (3) removal of >85% of the CO₂ from the PSA exhaust; (4) an increase in overall reaction conversion of methane by from about 10% to about 20%; and (5) recovery of from about 70% to about 90% of the CH₄ from the PSA exhaust. The technological benefits of the embodiment include: (1) operation occurs at low pressure with a minimal energy input; and (2) the overall hydrogen recovery of the H₂ purification system is improved. Table 3 lists the RAM feed composition, the RAM product composition, The RAM purge, and the RAM exhaust.

TABLE 3

| | RAM Feed | RAM Product | RAM Purge | RAM Exhaust |
|---|---|---|---|---|
| | (342) | (344) | (346) | (348) |
| H₂ | 20-45% | ~40-50% | | 0-10% |
| CO₂ | 25-60% | <10% | | 10-40% |
| CO | 0-20% | 0-30% | | >5% |
| CH₄ | 0-20% | 0-30% | | >5% |
| N₂ | | 10-20% | ~100% | 50-80% |
| Relative | 1.0 | ~0.5 | ~1.0 | 1.5 |
| Flow | | | | |
| H₂ | | 70-90% | | |
| Recovery | | | | |

### Example 4

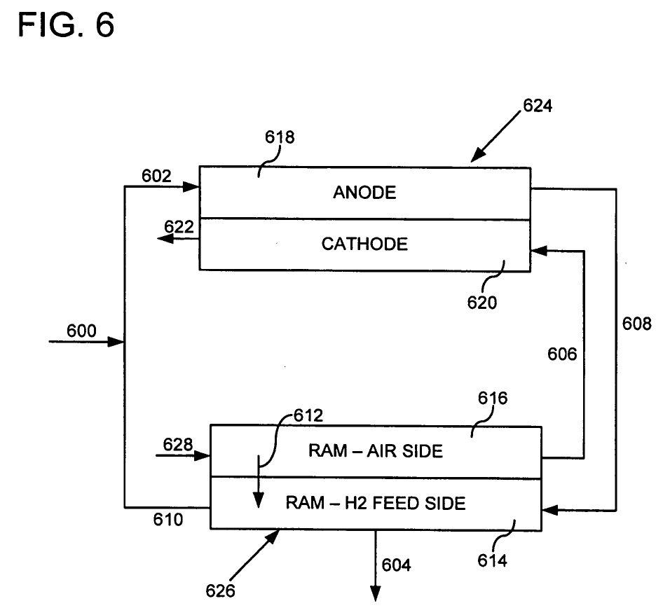

This example concerns hydrogen recovery/CO₂ transfer in an MCFC. It refers to features exemplified by FIG. 6. FIG. 6 is a schematic process flow diagram illustrating an embodiment of the present invention comprising a displacement purge adsorptive bulk separation fuel gas upgrading system for hydrogen recovery/CO₂ transfer from the anode exhaust 608 of an MCFC 624 containing low quality H₂. The embodiment comprises a displacement purge adsorptive bulk separator rotary adsorption module (RAM) 626. MCFC 624 has an anode 618, and an MCFC cathode 620. MCFC 624 receives a feed stream 600. RAM 626 includes a RAM air side 616, and a RAM hydrogen feed side 614. An air leak 612 flows from the RAM air side 616 to the RAM hydrogen feed side 614. RAM 626 includes a RAM air inlet 628 and a RAM waste stream 604.

Anode exhaust 608 from an MCFC 624 contains low quality H₂ at low pressure (˜14.9 psia). Typically this hydrogen is combusted and the products of combustion sent to the cathode inlet 606, which requires recovering >50% of the CO₂ in the anode exhaust back to the cathode inlet 606 for continuous MCFC 624 operation. Thus an opportunity exists in such systems for efficient hydrogen recovery from the anode exhaust 608 for re-introduction to the anode inlet 602 via conduit 610.

The technological benefits of the current embodiment include: (1) operation at essentially the system pressure of the MCFC 624 (thus no compression is required and the parasitic load on MCFC 624 is low); (2) reduced blower power because the structured adsorbent beds have a lower pressure drop than beaded beds for a given flow rate; and (3) improvement in the overall MCFC 624 power efficiency by from about 5% to about 20% by recovering hydrogen from anode exhaust 608.

TABLE 4

| | Anode Exhaust | RAM H₂ Product | RAM CO₂ Product |
|---|---|---|---|
| | (608) | (610) | (604-606) |
| H₂ | ~34% | ~64% | ~3% |
| CO₂ | ~55% | ~8% | ~19% |
| CO | ~1% | ~2% | |
| N₂ | ~10% | ~26% | ~78% |
| Relative Flow | 1.0 | ~0.4 | ~2.7 |
| H₂ Recovery | | ~70-90% | ~70-95% |

It will be understood that the above exemplary embodiments and applications may be adapted or varied without departing from the spirit of the present invention. The scope of the invention is more particularly determined by the following claims.

We claim:

1. A system for adsorptive bulk separation of a gas stream having at least a first component and a diluent component, comprising:
a displacement purge adsorptive separator operably coupled to a feed gas source, the separator comprising at least one adsorbent bed, at least one purge gas source for displacement purge regeneration of the at least one adsorbent bed, and a product conduit for supplying a gas product, the displacement purge adsorptive separator apparatus being operable to adsorb at least a portion of the at least one diluent component from the feed gas, thereby producing a gas product; and
a second fluid processing device fluidly coupled to the displacement purge adsorptive separator, the feed gas source, or both, the second fluid processing device being selected from the group consisting of an adsorptive fluid separator, an engine, and combinations thereof.

2. The system according to claim 1 where the feed gas comprises at least one fuel gas component and at least one diluent component, and the displacement purge adsorptive separator adsorbs at least a portion of the at least one diluent component from the feed gas to produce an upgraded fuel gas.

3. The system according to claim 2 where the feed source comprises landfill gas, and the engine comprises a natural gas engine that is powered by the upgraded fuel gas.

4. The system according to claim 1 wherein the displacement purge adsorptive separator is a rotary displacement purge adsorptive separator comprising plural adsorbent beds comprising adsorbent material and configured as parallel passage adsorbent beds.

5. The system according to claim 1 further comprising a feed blower upstream of the bulk displacement separator.

6. The system according to claim 1 further comprising a feed blower downstream of the bulk displacement separator.

7. The system according to claim 1 further comprising a feed blower to provide feed gas to the system at a pressure higher than the ambient pressure but substantially lower than a corresponding pressure swing adsorption feed pressure.

8. The system according to claim 1 where the feed gas is digester gas provided by a digester.

9. The system according to claim 2 where the at least one fuel gas component comprises methane, and the at least one diluent component comprises carbon dioxide, the adsorbent materials being selected for separating the fuel gas component from the diluent.

10. The system according to claim 9 further comprising a purge gas source to provide a purge gas selected from air, oxygen depleted air, nitrogen, steam, fuel gas, or combinations thereof.

11. The system according to claim 2 fluidly coupled to a coke oven to provide a coke oven feed gas, fluidly coupled to a blast furnace to provide a blast furnace feed gas, or to a fuel purification system to provide exhaust gas as the feed gas.

12. The system according to claim 11 where the at least one fuel gas component comprises hydrogen, and the at least one diluent component comprises carbon dioxide, the adsorbent materials being selected for separating the fuel gas component from the diluent.

13. The system according to claim 1 wherein the pressure drop between the feed and the product is less than 1 bar.

14. The system according to claim 1 wherein the pressure drop between the feed and the product is less than 0.5 bar.

15. The system according to claim 2 where the system further comprises a steam reformer hydrogen generator and the product of the bulk separator used to upgrade hydrogen pressure swing adsorption exhaust gas is returned back to an inlet of the steam reformer hydrogen generator.

16. The system according to claim 1 wherein the one or more adsorbent material have been layered or mixed and configured as parallel passage adsorbent bed.

17. The system according to claim 1 where the adsorptive separator is downstream of the displacement purge adsorptive separator.

18. The system according to claim 1 where the adsorptive separator is upstream of the displacement purge adsorptive separator.

19. The system according to claim 1 comprising a natural gas engine downstream of the bulk displacement fluid separator.

20. The system according to claim 1 further comprising at least one additional purification system.

21. The system according to claim 20 where the at least one additional purification system is upstream of the displacement purge adsorptive separator.

22. The system according to claim 21 comprising a separate pre-treatment system configured to remove contaminant components selected from particulates, hydrocarbons having 4 or more carbon atoms, sulfur compounds, water, siloxanes, and combinations thereof.

23. The system according to claim 2 where the source is a biomass digester which produces a feed gas at substantially ambient pressure comprising a methane fuel component and a carbon dioxide diluent component, and potentially additional contaminant or other minor diluent components, the system further comprising a pre-treatment system to substantially remove any contaminant component that may interfere with the adsorptive upgrading of the digester gas stream.

24. The system according to claim 23 where the bulk displacement purge separator is fluidly coupled to a downstream pressure swing adsorption separator.

25. The system according to claim 24 further comprising a compressor upstream of the pressure swing adsorption separator.

26. The system according to claim 1 further comprising a pressure swing adsorption separator upstream of the bulk displacement purge separator, the system further comprising a fluid conduit for coupling upgraded fluid from the bulk displacement purge separator to an fluid inlet for the pressure swing adsorption device.

27. The system according to claim 26 further comprising a compressor fluidly coupled to the bulk displacement purge separator to receive and compress an upgrade fluid stream for feed to the pressure swing adsorption device, tail gas from the pressure swing adsorption device serving as a feed source for the displacement purge separator.

28. The system according to claim 1 further comprising a pressure swing adsorption separator downstream of the bulk displacement purge separator, the system further comprising a fluid conduit for coupling upgraded fluid from the bulk displacement purge separator to an fluid inlet for the pressure swing adsorption device.

29. The system according to claim 28 further comprising a compressor fluidly coupled to the bulk displacement purge separator to receive and compress an upgraded fluid stream for feed to the pressure swing adsorption device.

30. The system according to claim 2 where the feed source is blast furnace gas, the system further comprising a water gas shift module to produce blast furnace feed gas stream comprising at least a hydrogen fuel gas component and a diluent gas component that is supplied to the displacement purge bulk separator for adsorption of at least a portion of the diluent gas component on suitable adsorbent materials, thereby producing upgraded fuel gas for downstream further purification by a pressure swing adsorption device.

31. The system according to claim 30 further comprising a compressor for supplying compressed upgraded fuel gas to the pressure swing adsorption device.

32. The system according to claim 2 comprising a coke oven gas purification device upstream of the displacement purge adsorptive bulk separator.

33. The system according to claim 32 further comprising a pretreatment module for pretreating coke oven gas feed to substantially remove contaminant components to produce a pre-treated coke oven gas.

34. The system according to claim 33 further comprising a compressor to compress pre-treated coke oven gas for supply to a pressure swings adsorption purification device.

35. A displacement purge adsorptive bulk separation fuel gas upgrading system for hydrogen recovery/CO₂ transfer from an anode exhaust of an molten carbonate fuel cell containing low quality hydrogen, comprising:
a displacement purge adsorptive bulk separator having an air side and a hydrogen feed side; and
a fuel cell having an anode and a cathode, the anode being fluidly coupled to a feed inlet for the hydrogen feed side of displacement purge adsorptive bulk separator, the anode providing low quality hydrogen at a relatively low pressure to the displacement purge adsorptive bulk separator, which provides an upgraded hydrogen feed from the displacement purge adsorptive bulk separator to the anode feed, the cathode being fluidly coupled to the air side of the displacement purge adsorptive bulk separator to receive a fluid stream comprising carbon dioxide.

36. The system according to claim 35 where the fuel cell is a molten carbonate fuel cell.

37. The system according to claim 35 where the displacement purge adsorptive bulk separator is a rotary adsorption module.

38. A method for providing a gas product, comprising:
providing a system comprising a bulk displacement purge adsorption separator fluidly coupled to at least one additional fluid stream processing device selected from an adsorptive fluid separator, an engine, or both; and
supplying a feed gas stream to the system to produce an upgraded product gas.

39. The method according to claim 38 where the feed stream comprises at least a fuel gas component and a diluent component, the system producing an upgraded fuel gas product.

40. The method according to claim 38 further comprising supplying the feed gas stream to the system at substantially ambient pressure.

41. The method according to claim 38 further comprising providing at least one additional purification system fluidly coupled to the bulk displacement purge separator, the adsorptive fluid separator, the engine, and any and all combinations thereof.

42. The method according to claim 38 where the bulk displacement purge adsorption system is upstream of the adsorptive separation device.

43. The method according to claim 38 where the bulk displacement purge adsorption device is downstream of the adsorptive fluid separator.

44. The method according to claim 38 wherein the bulk displacement purge separator is a rotary module.

45. The method according to claim 38 where the at least one additional adsorptive fluid separator is a pressure swing adsorption device.

46. The method according to claim 45 where the pressure swing adsorption device is a rotary pressure swing adsorption device.

47. The method according to claim 38 where the bulk displacement purge separator has one or more adsorbent materials layered or mixed and configured as parallel passage adsorbent beds.

48. The method according to claim 39 where the at least one additional adsorptive fluid separator is downstream of the bulk displacement purge separator and the method comprises supplying upgraded fuel gas product to the adsorptive fluid separator to purify the upgraded fuel gas product to produce a purified fuel gas product.

49. The method according to claim 39 wherein the feed gas is landfill gas, biogas, digester gas, anaerobic digester gas, natural gas or coalbed methane gas.

50. The method according to claim 39 where the at least one fuel gas component comprises methane.

51. The method according to claim 39 where the at least one diluent component comprises carbon dioxide.

52. The method according to claim 38 comprising purging the bulk displacement purge separator using air, oxygen depleted air, nitrogen, steam, fuel gas, or combinations thereof, as the purge gas.

53. The method according to claim 39 where the feed gas is coke oven gas, blast furnace gas, or fuel purification system exhaust gas.

54. The method according to claim 39 where the at least one fuel gas component comprises hydrogen.

55. The method according to claim 54 where the at least one diluent component comprises carbon dioxide.

56. The method according to claim 38 where a feed pressure is higher than ambient pressure but substantially lower than a corresponding pressure swing adsorption feed pressure.

57. The method according to claim 38 where energy efficiency is increased by more than 20% compared to a system not utilizing an adsorptive bulk separator.

58. The method according to claim 39 where fuel gas recovery efficiency is greater than 70% in a product stream as compared to the feed.

59. The method according to claim 39 where diluent gas recovery efficiency is greater than 85% in a product stream as compared to the feed.

60. The method according to claim 39 where a substantially pure fuel gas purge stream is used to reduce non-fuel purge component concentrations in the product stream.

61. The method according to claim 60 where the substantially pure fuel gas purge stream is recovered greater than 95% in the product stream.

62. The method according to claim 38 where pressure drop between feed and product is less than 1 bar.

63. The method according to claim 38 where pressure drop between feed and product is less than 0.5 bar.

64. The method according to claim 39 where the bulk separator is used to upgrade hydrogen pressure swing adsorption exhaust gas, which is supplied to an inlet of a steam reformer hydrogen generator.

65. The method according to claim 39 where the bulk displacement purge adsorption system is a rotary displacement purge adsorptive separator, and the adsorptive separator is a pressure swing adsorption device.

66. The method according to claim 39 useful for providing an upgraded fuel gas, comprising:
providing an adsorptive bulk separator for receiving a feed gas stream from a feed gas source, the adsorptive bulk separator comprising multiple adsorbent beds comprising adsorbent material suitable for adsorptive separation of at least a portion of a diluent component of the feed gas stream to provide an upgraded fuel gas relatively depleted in carbon dioxide relative to the feed gas, and relatively enriched in methane fuel gas component relative to the feed gas; and
substantially desorbing adsorbed diluents from the adsorbent material by displacement purge using a purge gas stream.

67. The method according to claim 66 where the adsorbent materials comprise molecular sieve materials, natural and synthetic zeolites, titania based materials, activated carbon, alumina- and/or silica-based materials, and functional-impregnated adsorbent materials, and any and all combinations of such materials.

68. The method according to claim 66 where the feed gas source is landfill gas and/or digester gas.

69. The method according to claim 66 where the feed gas stream comprises more than one diluent gas component, at least a portion of multiple such diluent gas components being adsorptively removed from the feed gas stream by the adsorptive bulk separator to deliver an enriched fuel gas component.

70. The method according to claim 69 where the feed gas stream includes both water and carbon dioxide diluent components that are adsorptively separated from the fuel gas component to yield an enriched fuel gas product stream.

71. The method according to claim 66 where the purge gas stream is substantially free of the diluent gas component to be purged from the adsorbent, and suitable to substantially desorb the adsorbed diluent gas component from the adsorbent.

72. The method according to claim 66 further comprising pressure and/or temperature swing processes in addition to a displacement purge process to facilitate desorption of adsorbed diluent on the adsorbent.

73. The method according to claim 66 where the purge gas is air, oxygen depleted air, predominantly nitrogen gas mixtures, steam, enriched fuel gas, or combinations of any or all of the above gas streams.

74. The method according to claim 73 comprising using purge gas streams sequentially.

75. The method according to claim 66 for upgrading a methane fuel component of a landfill gas produced at substantially ambient atmospheric pressure.

76. The method according to claim 75 optionally comprising at least one separate pre-treatment system to remove a contaminant component or components to produce a methane-fuel-containing landfill gas as the feed stream to an upgrading system.

77. The method according to claim 76 where the displacement purge adsorptive separator comprises a multi-bed, rotary displacement purge adsorptive separator.

78. The method according to claim 77 where the adsorbent beds preferably comprise parallel passage contactor adsorbent beds comprising at least an activated alumina and/or silica gel adsorbent material suitable to adsorb at least a portion of a carbon dioxide diluent component.

79. The method according to claim 78 where air or oxygen-depleted air is used as a purge gas to desorb adsorbed carbon dioxide diluent from the adsorbent.

80. The method according to claim 66 useful for producing an upgraded methane fuel gas product for combustion fuel use in natural gas reciprocating engines used to generate electrical power in generation installations at landfill gas collection sites.

81. The method according to claim 66 useful for producing an upgraded methane fuel component of a digester gas produced as a product of a biomass digester produced at substantially ambient pressure.

82. The method according to claim 66 where the feed stream comprises a hydrogen fuel gas component and at least one diluent gas component from an anode exhaust gas from a high temperature fuel cell.

83. The method according to claim 82 where the adsorbent is an activated carbon-based adsorbent material for adsorbing at least a portion of a carbon dioxide diluent component from the feed gas stream to produce an upgraded hydrogen fuel gas product depleted in carbon dioxide relative to the feed gas stream.

84. The method according to claim 83 where the purge gas is air and/or nitrogen-rich purge gas.

85. The method according to claim 38 for providing upgraded tailgas, comprising:
providing an adsorptive purification system for receiving a tailgas exhaust feed stream;
providing a downstream bulk displacement purge adsorptive separation system; and
supplying tailgas exhaust feed stream from the adsorptive purification system to the downstream bulk displacement purge adsorptive separation system to produce upgraded tailgas.

86. The method according to claim 85 where the adsorptive purification system is a pressure swing adsorption system operating to purify a fuel feed gas stream to produce purified fuel gas product by substantial adsorption of non-fuel components of the gas feed stream.

87. The method according to claim 86 where adsorbed non-fuel components are subsequently desorbed by purging with a portion of purified fuel gas product to form pressure swing adsorption exhaust gas comprising at least a fuel gas component and a diluent gas component.

88. The method according to claim 87 where the adsorptive bulk separator receives a portion of the pressure swing adsorption exhaust gas as tailgas feed stream to adsorb at least a portion of the diluent gas component to produce upgraded tailgas product.

89. The method according to claim 88 where any remaining portion of pressure swing adsorption tailgas is discharged as pressure swing adsorption waste gas to prevent accumulation of any gas component in the pressure swing adsorption exhaust gas within a displacement purge bulk separation system loop recycling back to the pressure swing adsorption as feed.

90. The method according to claim 89 where upgraded tailgas product is recycled for combination with fuel feed gas stream prior to compression in a pressure swing adsorption feed compressor and supply to the pressure swing adsorption device as compressed pressure swing adsorption feed gas.

91. The method according to claim 90 where the upgraded tailgas comprises a portion of the fuel gas component lost in the pressure swing adsorption process as part of pressure swing adsorption exhaust gas, thereby returning such portion of fuel gas to the pressure swing adsorption for additional separation to advantageously increase fuel gas component recovery from the fuel feed gas achieved by the pressure swing adsorption system.

92. The method according to claim 85 where a diluent gas component from the tailgas feed stream is desorbed by displacement purge by a purge gas to form purge exhaust.

93. The method according to claim 85 where the displacement purge adsorptive bulk separation system operates at substantially ambient pressure of the pressure swing adsorption exhaust gas to enhance fuel gas recovery performance.

94. The method according to claim 85 where the feed stream comprises a fuel feed gas stream comprising hydrogen reformate from a fuel reformer, and the adsorptive purification system comprises a hydrogen purification pressure swing adsorption to produce purified hydrogen product gas and desorbed pressure swing adsorption exhaust gas.

95. The method according to claim 94 where pressure swing adsorption exhaust gas comprises at least a hydrogen fuel gas component and a carbon dioxide diluent gas component, and the displacement purge adsorptive bulk separation system adsorbs at least a portion of the carbon dioxide diluent gas component to produce an upgraded hydrogen tailgas product for return as a pressure swing adsorption feed stream.

96. The method according to claim 95 where the displacement purge adsorptive bulk separator is configured for hydrogen upgrading and carbon dioxide adsorption, including suitable adsorbent material for adsorbing carbon dioxide diluent gas, and comprises a rotary adsorption apparatus with multiple, parallel passage adsorbent beds.

97. The method of claim 38 where the feed gas stream passes through a conventional flue gas pretreatment module to remove any contaminant gas present.

98. The method of claim 38 wherein the feed gas stream passes through a conventional water gas shift module to convert at least a portion of any carbon monoxide present in the stream into hydrogen fuel gas via the water gas shift reaction.

99. The method of claim 38 wherein the supplied feed gas stream originates in a steel making furnace, a blast furnace flue gas, or a basic oxygen furnace.

100. The method of claim 39 where an upgraded fuel gas product is supplied to the adsorptive purification system via a feed compressor to become compressed fuel feed gas.

101. A method for upgrading hydrogen recovery/CO₂ transfer from an anode exhaust of an molten carbonate fuel cell containing low quality hydrogen, comprising:
providing a displacement purge adsorptive bulk separator;
providing a fuel cell having an anode and a cathode, the anode being fluidly coupled to a feed inlet for the displacement purge adsorptive bulk separator, the anode providing low quality hydrogen at a relatively low pressure to the displacement purge adsorptive bulk separator; and
using the displacement purge adsorptive bulk separator to provide an upgraded hydrogen feed to the anode, the cathode being fluidly coupled to an air side of the displacement purge adsorptive bulk separator to receive a fluid stream therefrom.

102. The method according to claim 101 where the fuel cell is a molten carbonate fuel cell.
